(19) United States
(12) Patent Application Publication
(10) Pub. No.: US 2020/0220564 A1
(43) Pub. Date: Jul. 9, 2020

(54) TRANSCEIVERS FOR A WIRELESS COMMUNICATION SYSTEM, MOBILE DEVICE, AND METHOD FOR IMPROVING TRANSCEIVER LOOPBACK CALIBRATION ACCURACY

(71) Applicant: Apple Inc., Cupertino, CA (US)

(72) Inventors: Itay Almog, Ganey Tikva (IS); Oren Ezra Avraham, Givat Shmuel (IS); Yossi Dvash, Ramat Gan (IS); Shay Romano, Petah Tikva (IS); Avi Sulimarski, Kfar Oranim (IS); Sharon Zaguri, Haifa (IS)

(21) Appl. No.: 16/639,708

(22) PCT Filed: Aug. 18, 2017
(86) PCT No.: PCT/US2017/047498

§ 371 Date: Feb. 17, 2020

(51) Int. Cl. H04B 1/12; H04B 1/525; H04B 1/44; H04B 17/14; H04L 27/38; H04L 27/36

(52) U.S. Cl. CPC H04B 1/12; H04B 1/525; H04L 27/364; H04B 17/14; H04L 27/3863; H04B 1/44

(57) ABSTRACT

A transceiver for a wireless communication system is provided. The transceiver includes a transmit path and a receive path. Further, the transceiver includes a loopback path operatively coupled between the transmit path and the receive path. The loopback path includes only passive elements for processing radio frequency signals, and no external energy source may contribute to a magnitude of the element's output. Accordingly, the loopback path may prevent the transmit path to the receive path leakage via a common supply or ground plane.

### FIELD

Examples relate to transceivers. In particular, examples relate to transceivers for a wireless communication system, a mobile device comprising a transceiver, and a method for improving transceiver loopback calibration accuracy.

### BACKGROUND

Increasing communication data rates impose strict quality requirements for transmitters and receivers used in wireless or wired telecommunication systems. In order to fulfill the requirements, transceivers may require loopback (LPBK)-aided calibrations since transmit and receive paths of the transceivers (TX/RX circuit) may exhibit various impairments, which may be hard to predict, as for example IQ-imbalance and power amplifier nonlinearity. However, the LPBK itself may have various imperfections, which can affect the aforementioned calibration mechanisms and degrade the performance. There may be a desire to increase the quality of LPBKs in a transceiver.

### BRIEF DESCRIPTION OF THE FIGURES

Some examples of apparatuses and/or methods will be described in the following by way of example only, and with reference to the accompanying figures, in which

FIG. 1 illustrates an example of a transceiver;

FIG. 2 illustrates another example of a transceiver;

FIG. 3 illustrates an example of a radio frequency transmit signal;

FIG. 4 illustrates another example of a radio frequency transmit signal;

FIG. 5 illustrates an example of a relation between a duty cycle of an oscillation signal and an amount of third harmonics in the oscillation signal;

FIG. 6 illustrates an example of a course of an error vector magnitude for a conventional transceiver;

FIG. 7 illustrates an example of a course of an error vector magnitude for a transceiver according to examples;

FIG. 8 illustrates an example of a mobile device comprising a transceiver;

FIG. 9 illustrates a flowchart of an example of a method for improving transceiver loopback calibration accuracy; and

FIG. 10 illustrates another example of a transceiver.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

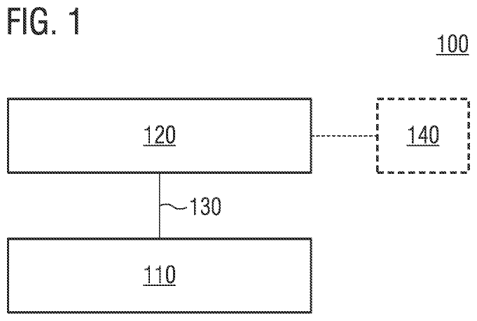

FIG. 1 illustrates an exemplary transceiver 100 for an exemplary wireless communication system. The transceiver 100 comprises a transmit path 110 and a receive path 120. Further, the transceiver 100 includes a LPBK path 130 operatively coupled between the transmit path 110 and the receive path 120. The LPBK path 130 comprises only passive elements to process radio frequency signals.

The transmit path 110 comprises components or circuitry required to generate a wireless communication signal that can, for example, be provided to an antenna element so as to be radiated into the environment. Some examples of transmit paths 110, therefore, may comprise a Power Amplifier (PA) in front of or upstream the antenna element to amplify a radio frequency signal generated within the transmit path. Likewise, the receive path 120 contains circuitry or elements required to process signals as received from an antenna element in order to determine information received by, for example, a received radio frequency signal. In some examples, the receive path 120 serves to receive data signals during a regular (normal) operation mode of the wireless communication circuit, while the same receive path 120 may serve for calibration purposes in a calibration mode. In other examples, the receive path 120 may be a dedicated receive path which is used for monitoring/calibration only while a further receive path is used to receive data in the normal operation mode.

In a wireless communication system, transmit paths may optionally further include a modulation circuit in order to convert the information to be submitted to a baseband signal according to the presently used modulation scheme. Further, a subsequent mixing circuitry to up-convert the baseband signal to the radio frequency signal used to radiate the information may be present. Likewise, receive paths may include a down converter and a subsequent demodulation circuit in order to recover the logical information transported by means of the radio frequency communication signal. However, the term transmit path 110 and receive path 120 as used herein shall not be construed to include all the components technically necessary in order to generate a radio frequency signal or to recover the logical information transmitted by means of the radio frequency signal. To the contrary, a transmit path 110 or a receive path 120 as used in the context of the present description may comprise only a subset of those components or elements.

One of the reasons for LPBK distortions (e.g. AM/AM, AM/PM or Memory Effect, ME, distortions) is leakage from the transmit path 110 to the receive path 120 (known as TX to RX leakage) via the LPBK path. TX to RX leakage may occur due to the coupling of active elements for processing radio frequency signals in the transmit path, the receive path and the LPBK path of a transceiver to a common supply or ground plane. An active device is one which is connected to an external energy source, so that the external energy source may contribute to the magnitude of the element's output. The LPBK 130 of transceiver 100 uses only passive devices for processing radio frequency signals, i.e., devices that are not coupled to any energy source, so that no external energy source may contribute to the magnitude of the element's output. Accordingly, the LPBK path 130 may prevent TX to RX leakage via a common supply or ground plane.

If the TX to RX leakage from the transmit path 110 to the receive path 120 via the LPBK path 130 is reduced or—ideally—nearly eliminated, the accuracy of a LPBK calibration of the transceiver 100 may be increased. If the accuracy of the LPBK calibration is increased, a model, e.g. a pre-distortion model, determined by the LPBK calibration can be determined with a greater accuracy. This, in turn, may result in a higher quality of the signal generated by the transmit path 110, if the model determined by the LPBK calibration is used during regular operation to pre-distort the signal or to correct for other imperfections of components within the transmit path 110. Consequently, when the TX to RX leakage from the transmit path to the receive path via the LPBK path is reduced according to the examples described herein, a transceiver can be provided which generates a transmit signal that may be compliant also with highly-demanding signal quality requirements.

TX to RX leakage via a LPBK path may further occur due to the coupling of inductors in the transmit path 110, the receive path 120, the LPBK path or an intersecting junction. The coupling causes electromagnetic leakage from the transmit path to the receive path. In some examples, the LPBK path may, hence, be free from inductor elements. Accordingly, electromagnetic leakage form the transmit path 110 to the receive path 120 via the LPBK path 130 may be avoided. The accuracy of the LPBK calibration of the transceiver 100 may therefore be increased.

According to some examples, the LPBK path 130 may further comprise at least one attenuation element so as to appropriately attenuate the transmit path 110's output signal to avoid exceeding the receive path 120's dynamic range. The attenuation element may be adjustable.

The receive path 120 may comprise a radio frequency section operating in a radio frequency domain (i.e. processing radio frequency signals), and a baseband section operating in a baseband frequency domain (i.e. processing baseband signals). For example, the baseband frequency section of the receive path 120 may comprise all components of the receive path 120 downstream of a mixing circuit of the receive path 120, and the radio frequency section may comprise the components up to the mixing circuit. In some examples, the LPBK path 130 may be coupled to the baseband section of the receive path 120.

When the LPBK path 130 is coupled to the baseband section of the receive path 120, the LPBK path 130 may comprise a mixing circuit (i.e. a down converter) configured to generate an analog baseband signal using an oscillation signal, so as to be able to provide a baseband signal to the baseband section of the receive path 120.

Another reason for LPBK distortions are harmonics in the transmit path 110's radio frequency transmit signal fed back to the receive path 120 via the LPBK path 130. For example, third harmonics in an oscillation signal used for up converting the baseband transmit signal in the transmit path 110 may result in artefacts at three times the nominal frequency of the oscillation signal (i.e. at three times the carrier frequency of the radio frequency transmit signal). Also further components like the PA of the transmit path 110 may exhibit nonlinearities and introduce third harmonic artefacts at three times the carrier frequency of the radio frequency transmit signal. Also the oscillation signal used in the LPBK path 130 for generating the analog baseband signal based on the radio frequency transmit signal may comprise third harmonics in addition to its nominal frequency. Hence, the artefacts in the radio frequency transmit signal may be down-converted to the baseband by the LPBK path 130's mixing circuit.

In order to avoid down-mixing of the artefacts in the radio frequency transmit signal, the LPBK path 130 may further comprise a control circuit configured to adjust a duty cycle of the oscillation signal used by the mixing circuit of the LPBK path 130 to about one third. The duty cycle is the fraction of one period of the oscillation signal in which the oscillation signal is high. By setting the duty cycle of the oscillation signal to one third, third harmonics in the oscillation signal may be suppressed. That is, the oscillation signal may be free or almost free from third harmonics. Accordingly, a down conversion of the artefacts in the radio frequency transmit signal at three times the carrier frequency of the radio frequency transmit signal to the analog baseband signal by the mixing circuit may be avoided. The accuracy of the LPBK calibration of the transceiver 100 may therefore be increased.

Additionally, the LPBK path may further comprise a first capacitor element coupled to an input of the mixing circuit, and a second capacitor element coupled to an output of the mixing circuit. The mixing circuit together with the first and the second capacitor elements may form a low-pass filter. The low-pass filter formed by the mixing circuit together with the first and the second capacitor elements may reject the artefacts in the radio frequency transmit signal at three times the carrier frequency of the radio frequency transmit signal directly in the radio frequency domain before they can be down-converted by the mixing circuit. The accuracy of the LPBK calibration of the transceiver 100 may therefore be increased. For example, in a differential implementation of the transceiver 100, the first capacitor element may be coupled between the differential inputs of the mixing circuit, and the second capacitor element may be coupled between the differential outputs of the mixing circuit. In a single-ended implementation of the transceiver 100, the first and the second capacitor elements may be further coupled (shunt) to ground.

In addition, the transceiver 100 may comprise a filter coupled between the transmit path 110 and the LPBK path 130. The filter is configured to attenuate frequency components of a signal input to the filter at three times the carrier frequency of the oscillation signal used in the LPBK path 130. In other words, the filter at least partly rejects the artefacts in the radio frequency transmit signal at three times the carrier frequency of the radio frequency transmit signal before the radio frequency transmit signal reaches the LPBK path 130. The accuracy of the LPBK calibration of the transceiver 100 may therefore be increased. For example, the filter may be implemented as a band stop filter (notch filter).

In some examples, the transceiver 100 may comprise a switch circuit coupled between the transmit path 110 and the filter. The switch circuit may be configured to couple the filter to the transmit path 110 downstream of the PA within the transmit path 110. This may allow to use the LPBK path 130 for LPBK calibrations using a Post-PA LPBK mode (e.g. Memory Power Amplifier Pre-Distortion, MPAPD, calibration). Alternatively or additionally, the switch circuit may be configured to couple the filter to the transmit path 110 upstream of the PA within the transmit path 110. This may allow to use the LPBK path 130 for LPBK calibrations using a Pre-PA LPBK mode.

As indicated above, the LPBK path 130 may be configured to supply, to the receive path 120, an analog baseband signal derived from a radio frequency transmit signal generated by the transmit path 110. That is, the LPBK path 130 may down convert a radio frequency signal to the baseband. For example, the mixing circuit of the LPBK path 130 may be configured to convert the radio frequency transmit signal of the transmit path 110 to a baseband signal comprising an in-phase (I) and a quadrature (Q) component. However, the generation of the in-phase and the quadrature component as well as the processing of both components within the LPBK path 130 may suffer from various imperfections. As a consequence in-phase/quadrature imbalance may occur. In-phase/quadrature imbalance may negatively affect the LPBK calibration of the transceiver 100. Hence, the transceiver 100 may further comprise a digital processor circuit 140 for compensating the imbalance.

The digital processor circuit 140 is configured to receive a first digital baseband signal on which the radio frequency transmit signal generated by the transmit path 110 is based. Further, the digital processor circuit 140 is configured to receive a second digital baseband signal derived from the analog baseband signal provided by the LPBK path 130. For example, the receive path 120 may comprises an Analog-to-Digital Converter (ADC) configured to generate the second digital baseband signal based on the analog baseband signal provided by the LPBK path 130. Based on the first digital signal and the second digital signal, the digital processor circuit 140 is configured to calculate a set of correction coefficients for compensating in-phase/quadrature imbalance within the LPBK path 130. The set of correction coefficients may be used to correct for the in-phase/quadrature imbalance caused by the LPBK path 130.

The calculation of the set of correction coefficients may be based on the assumption that the in-phase/quadrature imbalance of the second digital baseband signal compared to the first digital baseband signal is only caused by the in-phase/quadrature imbalance within the LPBK path 130. This assumption may be true if the radio frequency transmit signal provided by the transmit path is not influenced by in-phase/quadrature imbalance within the transmit path 110. In order to achieve this, the transmit path 110 may further comprise a pre-distortion circuit configured to modify the baseband transmit signal based on a first pre-distortion model for compensating in-phase/quadrature imbalance within the transmit path. The radio frequency transmit signal is, hence, based on the pre-distorted baseband transmit signal. For example, a mixing circuit of the transmit path 110 may up convert the pre-distorted baseband transmit signal which is then amplified by the transmit path 110's PA in order to provide the radio frequency transmit signal.

The radio frequency transmit signal provided by the transmit path 110 may be a regular radio frequency transmit signal carrying user data. That is, no dedicated calibration signal needs to be used for determining the set of correction coefficients. Accordingly, the transceiver 100 may determine the set of correction coefficients during regular operation of the transceiver 100 (i.e. no dedicated calibration mode is required), so that no down-time or throughput degradation of the transceiver 100 may occur. For example the radio frequency transmit signal may carry a legitimate WLAN/Wi-Fi (e.g. an OFDM) packet.

The set of correction coefficients may be taken into account during LPBK calibration of the transceiver in order to increase the accuracy of a LPBK calibration. For example, the digital processor circuit may be further configured to calculate a second pre-distortion model for the PA within the transmit path 110 using the set of correction coefficients and a calibration signal transmitted via the transmit path 110. By taking into account the set of correction coefficients, the in-phase/quadrature imbalance within the LPBK path 130 may be compensated so that the calibration process, and, hence, the second pre-distortion model is not or at least less affected by the in-phase/quadrature imbalance within the LPBK path 130. For example, the second pre-distortion model may be based on Memory Power Amplifier Pre-Distortion (MPAPD) calibration for compensating nonlinearities of the PA within the transmit path 110.

In order to apply the result of the calibration, the transmit path 110 may further comprise a pre-distortion circuit configured to modify the radio frequency transmit signal using the second pre-distortion model.

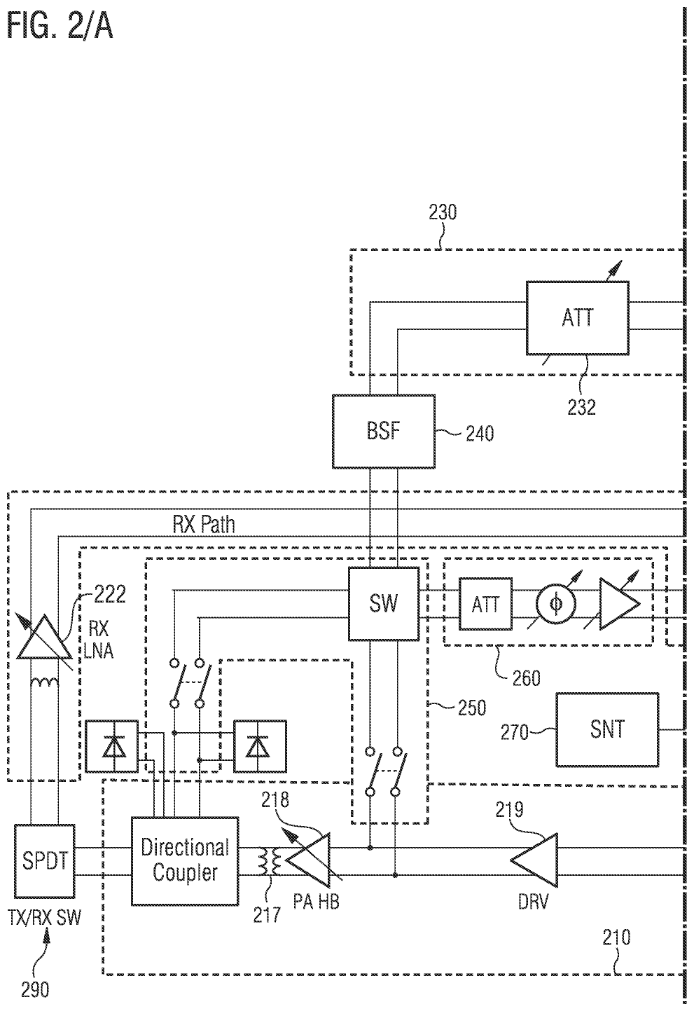

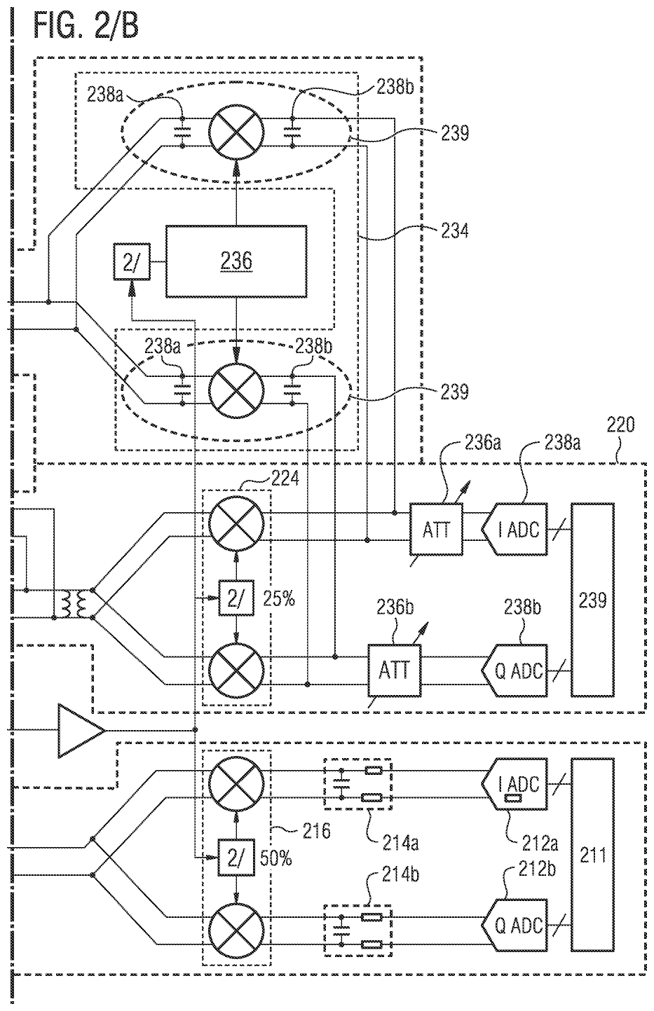

Another transceiver 200 comprising a transmit path 210 and a receive path 220 is illustrated in FIG. 2. For the purpose of the illustration, some components of the transmit path 210 and of the receive path 220 are illustrated. The exemplary transmit and receive paths use I/Q modulation. Further examples may optionally also use direct synthesis or polar transmitters. Also, the transceiver 200 is illustrated as differential implementation. Further examples may also include single-ended implementations of the transceiver 200.

The transmit path 210 serves to create a radio frequency transmit signal from a digital baseband transmit signal, the baseband transmit signal comprising the information to be transmitted via the radio frequency transmit signal. A digital processor circuit 211 within the transmit path 210 creates both an I-component and a Q-component of the digital baseband transmit signal. A first Digital-to-Analog Converter (DAC) 212a and a second DAC 212b serve to create analog representations of the I-component and Q-component, each DAC followed by low pass filters 214a and 214b to clear the spectrum, for example by deleting alias components. A first mixing circuit 216 is used to up-convert the I-component and the Q-component and to sum up both up-converted components to provide the radio frequency transmit signal. The so-generated radio frequency transmit signal is amplified by means of a PA 218. In between the first mixing circuit 216 and the PA 218, a driver circuit 219 for processing the radio frequency transmit signal may be provided. An output of the PA 218 is connectable to an antenna element in order to radiate the amplified radio frequency transmit signal into the environment. According to some examples, the connection between the PA 218 and the antenna element can optionally be opened and closed, for example by means of switch 290.

The receive path 220 comprises a Low-Noise Amplifier (LNA) 222 which is connectable to a receive antenna element. A received radio frequency signal is down-converted by means of the second mixing circuit 224 which is also separating the I-component and the Q-component of the down-converted baseband signal from one another. Adjustable attenuation elements 226a and 226b attenuate the I-component and the Q-component of the down-converted baseband signal to avoid exceeding the receive path 220's dynamic range before the analog representation of the I-component and the Q-component is digitized by means of ADCs 228a and 228b. A digital processor circuit 229 within the receive path 220 further processes the I-component and the Q-component of the down-converted baseband signal. The digital processor circuits 211 and 229 may in some examples be embodied by a single processor such as a digital signal processor.

The transceiver 200 further comprises a first LPBK path 230 which is coupled to the transmit path 210 by means of switch circuit 250. Via the switch circuit 250, the first LPBK path 230 may be coupled to the transmit path 210 upstream or downstream of PA 218.

The LPBK path 230 comprises an adjustable attenuation element 232 for attenuating the transmit path 210's output signal in order to avoid exceeding the receive path 220's dynamic range. Further, the LPBK path comprises a mixing circuit 234 configured to generate an analog baseband signal based on the transmit path 210's output signal using an oscillation signal. That is, the mixing circuit 234 provides the analog I-component and Q-component of the down-converted baseband signal. The oscillation signal is provided to the mixing circuit 234 by an oscillation control circuit 236. The oscillation control circuit 236 adjusts a duty cycle of the oscillation signal to about one third.

Further, a first capacitor element 238a coupled to the differential inputs of the mixing circuit 234, and a second capacitor element 238b coupled to the differential outputs of the mixing circuit 234 are provided in order to form a low-pass filter 239 together with the mixing circuit 234.

Additionally, a filter 240 that attenuates frequency components of the transmit path 210's output signal at three times the carrier frequency of the oscillation signal used by the mixing circuit 234 is coupled between the transmit path 210 and the LPBK path 230. The filter 240 may, e.g., be a band stop filter (notch filter) implemented by a combination of an inductor element and a capacitor element.

As discussed above in connection with FIG. 1, the duty cycle of the oscillation signal together with the low-pass filter 239 and the filter 240 may allow to avoid down conversion of artefacts in the transmit path 210's output signal to the analog baseband signal provided by the mixing circuit 234.

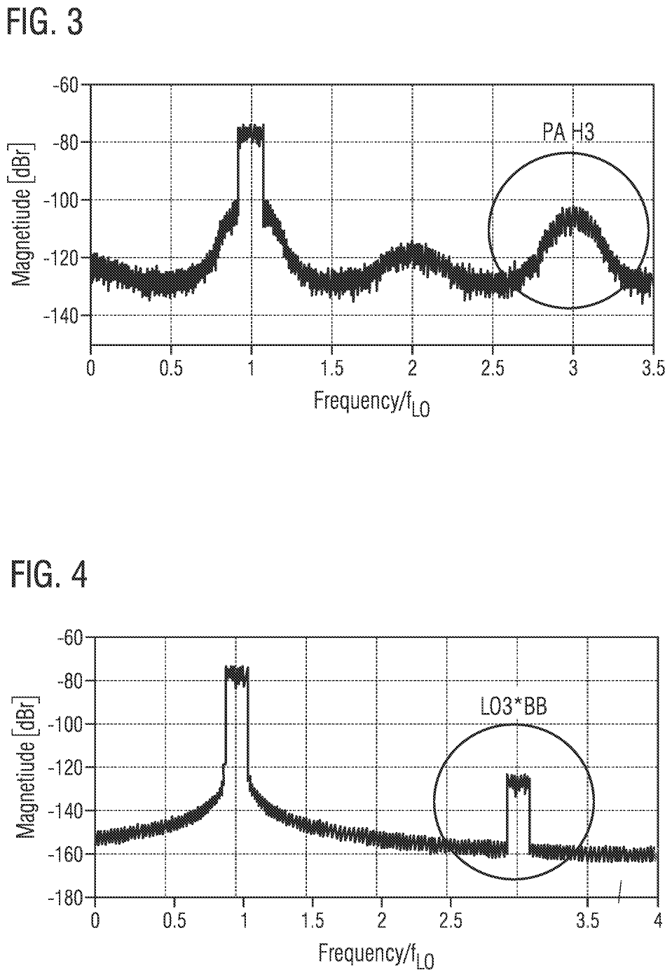

Two examples of artefacts in the transmit path 210's output signal are illustrated in FIGS. 3 and 4. FIG. 3 illustrates the transmit path 210's output signal. It is evident from FIG. 3 that the output signal contains in addition to the desired signal component at the frequency of 1 GHz an artefact at 3 GHz. This artefact is present due to third order nonlinearities of the PA 218. Moreover, FIG. 4 illustrates the transmit path 210's output signal before it is amplified by the PA 218. It is evident from FIG. 4 that already before amplification the output signal contains in addition to the desired signal component at the frequency of 1 GHz an artefact at 3 GHz. This is due to third harmonics in the oscillation signal used by the mixing circuit 216 to up convert the I and Q components of the baseband transmit signal.

By reducing (suppressing) the artefacts already in the transmit path 210's output signal by means of filter 240 and low-pass filter 239, and by rejecting third harmonics in the oscillation signal used by the mixing circuit 234 for down converting the transmit path 210's output signal, distortions (related to the artefacts) in the resulting analog baseband signal of the LPBK path 230 may be avoided or at least reduced.

For example, the oscillation control circuit 236 may receive a reference oscillation signal with a 50% duty cycle and process the oscillation signal through a plurality of inverters with varying slew-rate. The oscillation control circuit 236 may comprise two branches for separately processing an oscillation signal component for the I component and a 90° phase shifted oscillation signal component for the Q component. The two branches may drive a NAND gate of the oscillation control circuit 236. The oscillation signal components output by the NAND gate are a function of the slew-rate setting for the oscillation signal component for the I component and the oscillation signal component for the Q component, which may be configured to yield a duty cycle of about one third.

The relation between the amount of third harmonics in the oscillation signal provided by the oscillation control circuit 236 and its duty cycle is illustrated in FIG. 5. It is evident from FIG. 5 that the level of third harmonics in the oscillation signal is heavily reduced for a duty cycle of one third or a value close to it. Hence, by adjusting the oscillation signal's duty cycle to about one third, the oscillation signal may be provided free or almost free from third harmonics.

The LPBK path 230 comprises only passive elements for processing radio frequency signals. That is, the attenuator 232 as well as the mixing circuit 234 are passive elements. Accordingly, TX to RX leakage via a common power supply or ground plane may be avoided.

Further, the LPBK path 230 itself is free from inductor elements, i.e. it does not comprise any inductor elements. Accordingly, TX to RX leakage due to electromagnetic coupling may be avoided.

For example, if the LPBK path 230 would contain inductor elements, magnetic coupling between inductor elements in the transmit path 210 upstream of the PA 218 (e.g. driver circuit 219) and the inductor elements in the LPBK path may occur. The radio frequency signal processed upstream of PA 218 may exhibit different nonlinearities than the transmit path 210's output signal (since the output signal is amplified by the PA 218) so that AM/AM, AM/PM and/or memory effect distortions may be introduced into the radio frequency signal processed by the inductor elements in the LPBK path 230. Moreover, if the LPBK path 230 would contain inductor elements, magnetic coupling between inductor elements in the transmit path 210 downstream of the PA 218 (e.g. impedance matching coil 217) and the inductor elements in the LPBK path may occur. The radio frequency signal processed downstream of PA 218 may exhibit the same nonlinearities as the transmit path 210's output signal, so that a dynamic range of the LPBK 230's gain may be reduced. Depending on the delay between radio frequency signal processed downstream of PA 218 and the radio frequency signal processed by the inductor elements in the LPBK path 230, also memory effect distortions may be introduced.

By omitting inductor elements in the LPBK path 230, the above distortions may be avoided.

Additionally, the transceiver 200 comprises a second LPBK path 260. In contrast to the first LPBK path 230, the second LPBK path 260 comprises active elements for processing radio frequency signals.

Further illustrated is oscillation signal synthesizer 270 which synthesizes the reference oscillation signal and supplies it to mixing circuits 216 and 224 as well as oscillation control circuit 236.

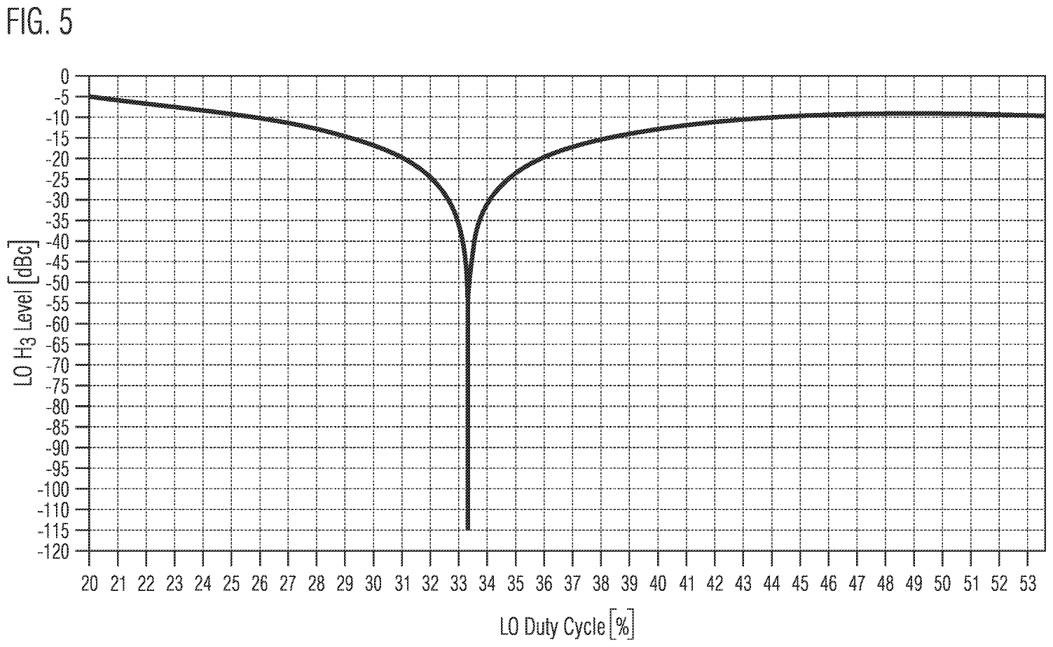

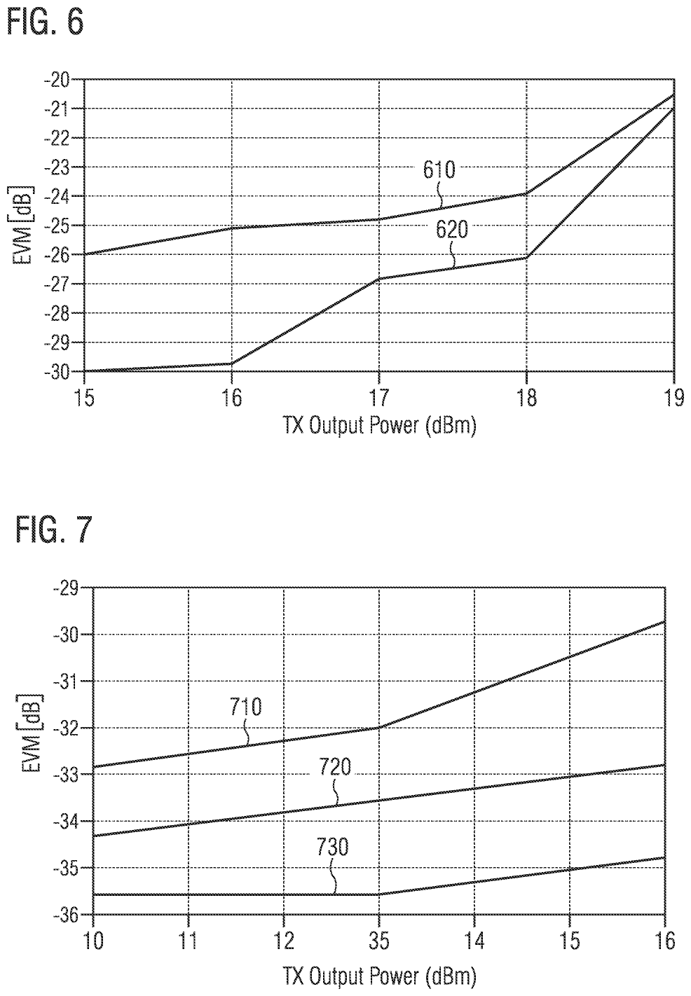

The passive and inductor-less LPBK path 230, the filter 240, the low-pass filter 230 and the adjustment of the oscillation signal's duty cycle to about one third may allow to increase the accuracy of a LPBK calibration of the transceiver 200. The effect of the above described features will become evident from FIGS. 6 and 7.

FIG. 6 illustrates the Error Vector Magnitude (EVM) of the transmit path's output signal for a conventional transceiver without the LPBK path 230 and filter 240 after the calibration of the transceiver. Line 610 illustrates the EVM for a closed-loop calibration, while 620 illustrates the EVM for an open-loop calibration. The EVM for the closed-loop calibration is degraded compared to the EVM for the open-loop calibration.

As a comparison, FIG. 7 illustrates the EVM for transceiver 200 after the calibration of the transceiver 200. Line 710 illustrates the situation where only the low-pass filter 239 and only passive elements in the LPBK path 230 are used, i.e., the duty cycle of the oscillation signal for the mixing circuit 234 is not set to one third and filter 240 is omitted. Line 720 illustrates the situation where in addition to the situation illustrated by line 710 the duty cycle of the oscillation signal for the mixing circuit 234 is set to one third. Line 730 illustrates the situation where in addition to the situation illustrated by line 730 the filter 240 is coupled between the transmit path 210 and the LPBK path 230. It is evident from FIG. 7 that the EVM for transceiver 200 is far lower than for the conventional transceiver.

As indicated above, the LPBK path 230 supplies, to the receive path 220, an analog baseband signal (I and Q component) derived by the mixing circuit 234 from the transmit path 210's output signal. However, the generation of the I and the Q component as well as the processing of both components within the LPBK path 230 may suffer from various imperfections. As a consequence in-phase/quadrature imbalance may occur. In-phase/quadrature imbalance may negatively affect the LPBK calibration of the transceiver 200. However, this may be compensated by means of digital processor circuit 229 within the receive path 220.

The digital processor circuit 229 receives the digital baseband transmit signal on which the transmit path's output signal is based. For example, the digital processor circuit 211 within the transmit path 210 or a memory coupled to the digital processor circuit 211 may provide the digital baseband transmit signal. The digital baseband transmit signal is free from in-phase/quadrature imbalance caused by imperfections of the transmit path 210.

Further, the digital processor circuit 229 receives a digital baseband receive signal derived by ADCs 238a and 238b from the analog baseband signal provided by the LPBK path 230.

For the calculation of correction coefficients for compensating the in-phase/quadrature imbalance within LPBK path 230, it is assumed that the in-phase/quadrature imbalance of the digital baseband receive signal compared to the digital baseband transmit signal is only caused by the in-phase/quadrature imbalance within the LPBK path 230. Therefore, the digital processor circuit 211 may modify the baseband transmit signal based on a first pre-distortion model for compensating in-phase/quadrature imbalance within the transmit path. The transmit path 210's output signal is, hence, based on the pre-distorted baseband transmit signal. Accordingly, the transmit path 210's output signal exhibits no or almost no phase/quadrature imbalance.

Based on the digital baseband transmit signal and the digital baseband receive signal, the digital processor circuit 229 calculates a set of correction coefficients for compensating in-phase/quadrature imbalance within the LPBK path 230. The set of correction coefficients may be subsequently used to correct for the in-phase/quadrature imbalance caused by the LPBK path 230.

In compact form, the relation between the digital baseband transmit signal, the set of correction coefficients and the digital baseband receive signal may be written as follows:

X·d=y (1),

with d denoting the set of correction coefficients, y denoting the digital baseband transmit signal in a vector representation, X denoting the digital baseband receive signal in a matrix representation. For example, X may be the observation matrix given by the ADCs 238a and 238b. y may be the signal vector prior to the pre-distortion for correcting the in-phase/quadrature imbalance caused by the transmit path 210.

For example, the digital processor circuit 229 may calculate the set of correction coefficients according to the least squares method based on an expression which is mathematically correspondent to

d=(X^{H}X)⁻¹X^{H}y (2),

with X^{H} denoting the Hermitian matrix of matrix X. Solving expression (2) may lead to a set of correction coefficients taking into account common (near DC) in-phase/quadrature imbalance as well as frequency selective in-phase/quadrature imbalance.

Considering only common (near DC) in-phase/quadrature imbalance, expression (2) may be simplified. For example, the digital processor circuit 229 may calculate the set of correction coefficients based on an expression which is mathematically correspondent to

$$[ \begin{matrix}{d}_{1} \\ {d}_{2}\end{matrix} ] = \frac{1}{{\sum }_{n = 1}^{N} {I}_{n}^{2} \cdot {\sum }_{n = 1}^{N} {Q}_{n}^{2} - ( {\sum }_{n = 1}^{N} {I}_{n} {Q}_{n} )} [ \begin{matrix}{\sum }_{n = 1}^{N} {Q}_{n}^{2} & - {\sum }_{n = 1}^{N} {I}_{n} {Q}_{n} \\ - {\sum }_{n = 1}^{N} {I}_{n} {Q}_{n} & {\sum }_{n = 1}^{N} {I}_{n}^{2}\end{matrix} ] \cdot [ \begin{matrix}{\sum }_{n = 1}^{N} {y}_{n} {I}_{n} \\ {\sum }_{n = 1}^{N} {y}_{n} {Q}_{n}\end{matrix} ] , \qquad ( 3 )$$

with d₁ and d₂ denoting first and second correction coefficients, lₙ denoting the real part of a matrix element xₙ of matrix X, Qₙ denoting the imaginary part of a matrix element xₙ of matrix X, and yₙ denoting vector elements of vector y.

As discussed above in connection with FIG. 1, the transmit path 210's output signal used for determining the set of correction coefficients may be a regular radio frequency transmit signal carrying user data. For example, transmit path 210's output signal may carry a legitimate WLAN/Wi-Fi (e.g. an OFDM) packet. Accordingly, the transceiver 200 may determine the set of correction coefficients during regular operation of the transceiver 200 (i.e. no dedicated calibration mode is required), so that no down-time or throughput degradation of the transceiver 200 occurs.

The set of correction coefficients may be taken into account during LPBK calibration of the transceiver 200 in order to increase the accuracy of a LPBK calibration. For example, the digital processor circuit 229 (or the digital processor circuit 211) may calculate a second pre-distortion model for the PA 218 within the transmit path 210 using the set of correction coefficients and a calibration signal transmitted via the transmit path 210. By taking into account the set of correction coefficients, the in-phase/quadrature imbalance within the LPBK path 230 may be compensated so that the calibration process, and, hence, the second pre-distortion model is not or at least less affected by the in-phase/quadrature imbalance within the LPBK path 230. For example, the second pre-distortion model may be based on MPAPD calibration for compensating nonlinearities of the PA 218 within the transmit path 210.

In order to apply the result of the calibration, the driver circuit 210 with the transmit path 210 may comprise a pre-distortion circuit (e.g. driver 219) configured to modify the radio frequency transmit signal of the transmit path 210 using the second pre-distortion model.

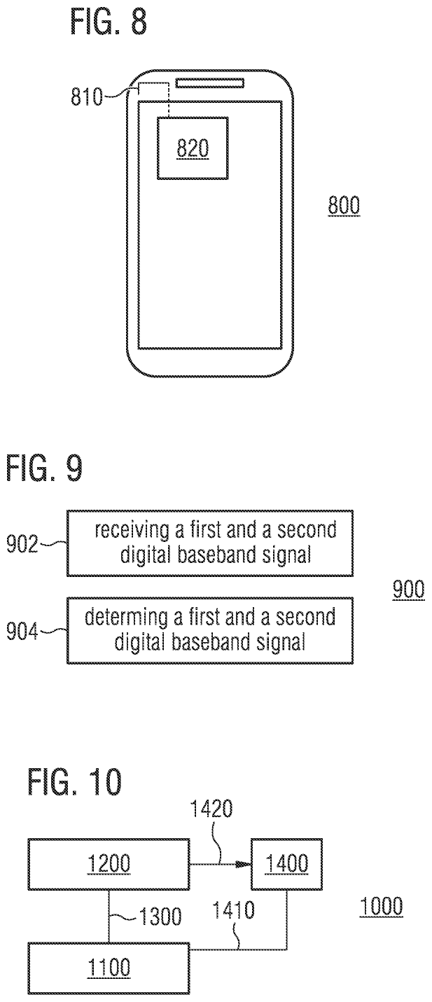

An example of an implementation using a transceiver according to one or more aspects of the proposed architecture or one or more examples described above is illustrated in FIG. 8. FIG. 8 schematically illustrates an example of a mobile device 800 (e.g. mobile phone, smartphone, tablet-computer, or laptop) comprising a transceiver 820 according to an example described herein. An antenna element 810 of the mobile device 800 may be coupled to the transceiver 820. To this end, mobile devices may be provided enabling top grade TX performance and efficiency as well as RF performance. In particular, high throughput and high range operation may be enabled.

An example of a method 900 for improving (increasing) transceiver loopback calibration accuracy is illustrated by means of a flowchart in FIG. 9. A receive path of the transceiver is (operatively) coupled to a transmit path of the transceiver via a LPBK path. The method 900 comprises receiving 902 a first digital baseband signal and a second digital baseband signal. A radio frequency transmit signal generated by the transmit path is based on the first digital baseband signal, and the second digital baseband signal is derived from an analog baseband signal. The analog baseband signal is generated by the loopback path based on the radio frequency transmit signal. The method 900 further comprises determining (e.g. calculating) 904, based on the first digital signal and the second digital signal, at least one correction coefficient (e.g. a set of correction coefficients) for compensating in-phase/quadrature imbalance within the LPBK path and/or the receive path.

The generation of the in-phase and the quadrature component as well as the processing of both components within the LPBK path or the receive path may suffer from various imperfections. As a consequence, in-phase/quadrature imbalance may occur. In-phase/quadrature imbalance may negatively affect the LPBK calibration of the transceiver. The set of correction coefficients may be used to correct for the in-phase/quadrature imbalance caused by the LPBK path and/or the receive path.

In some examples, the radio frequency signal may be a regular radio frequency transmit signal carrying user data.

As indicated above, the radio frequency transmit signal may be based on the baseband transmit signal, the baseband transmit signal being based on a first pre-distortion model for compensating in-phase/quadrature imbalance within the transmit path.

For example, determining 904 the at least one correction coefficient may be based on an expression which is mathematically correspondent to one of above expressions (2) and (3).

The loopback path may in some examples be coupled to the transmit path downstream of a power amplifier within the transmit path.

As indicated above, the LPBK path may comprise only passive elements for processing radio frequency signals. Also, the LPBK path may be free from inductor elements.

The receive path may in some examples comprise a baseband section operating in a baseband frequency domain, and the LPBK path may be coupled to the baseband section of the receive path.

In some examples, the LPBK path may comprise at least in part a radio frequency section of the receive path, wherein the radio frequency section operates in a radio frequency domain.

The method 900 may optionally further comprise performing a loopback calibration of the transceiver using the at least one correction coefficient. For example, performing the loopback calibration may comprise transmitting a calibration signal via the transmit path, receiving the calibration signal via the receive path, and calculating a second pre-distortion model for a power amplifier within the transmit path using the received calibration signal, the transmitted calibration signal and the set of correction coefficients.

More details and aspects of the method are mentioned in connection with the proposed concept or one or more examples described above (e.g. FIGS. 1-8). The method may comprise one or more additional optional features corresponding to one or more aspects of the proposed concept or one or more examples described above.

Further, FIG. 10 illustrates another transceiver 1000 for a wireless communication system. The transceiver comprises a receive path 1200 coupled to a transmit path 1100 of the transceiver via a LPBK path 1300. The transceiver 1000 additionally comprises a digital processor circuit 1400 configured to receive a first digital baseband signal 1410 and a second digital baseband signal 1420. A radio frequency transmit signal generated by the transmit path 1100 is based on the first digital baseband signal 1410, and the second digital baseband signal 1420 is derived from an analog baseband signal. The analog baseband signal is generated by the LPBK path 1300 based on the radio frequency transmit signal. The digital processor circuit 1400 is further configured to calculate, based on the first digital signal 1410 and the second digital signal 1420, a set of correction coefficients for compensating in-phase/quadrature imbalance within the LPBK path 1300 and/or the receive path 1200.

The generation of the in-phase and the quadrature component as well as the processing of both components within the LPBK path 1300 or the receive path 1200 may suffer from various imperfections. As a consequence, in-phase/quadrature imbalance may occur. In-phase/quadrature imbalance may negatively affect the LPBK calibration of the transceiver 1000. The set of correction coefficients may be used to correct for the in-phase/quadrature imbalance caused by the LPBK path 1300 and/or the receive path 1200.

The transceiver 1000 as well as its components (i.e. transmit path 1100, receive path 1200, LPBK path 1300 or digital processor circuit 1400) may incorporate or be configured to execute the further features and aspects discussed above in connection with method 900.

For example, a mobile device may comprise the transceiver 1000. At least one antenna element of the mobile device may be coupled to the transceiver 1000. To this end, mobile devices may be provided enabling top grade TX performance and efficiency as well as RF performance. In particular, high throughput and high range operation may be enabled.

Generally speaking, some examples relate to a means for improving (e.g. increasing) transceiver LPBK calibration accuracy, wherein a receive path of the transceiver is coupled a transmit path of the transceiver via a LPBK path. The means comprises a means for receiving a first digital baseband signal and a second digital baseband signal. A radio frequency transmit signal generated by the transmit path is based on the first digital baseband signal, and the second digital baseband signal is derived from an analog baseband signal. The analog baseband signal is generated by the loopback path based on the radio frequency transmit signal. The means further comprises a means for determining (e.g. calculating), based on the first digital signal and the second digital signal, at least one correction coefficient (e.g. a set of correction coefficients) for compensating in-phase/quadrature imbalance within the LPBK path or the receive path.

For example, the radio frequency signal may be a regular radio frequency transmit signal carrying user data.

The means for improving transceiver loopback calibration accuracy may be implemented by a transceiver for a wireless communication system described above or below (e.g. FIG. 1 or 10). The means for receiving a first digital baseband signal and a second digital baseband signal may be implemented by a digital processor circuit described above or below (e.g. FIG. 1 or 10). The means for determining at least one correction coefficient may be implemented by a digital processor circuit described above or below (e.g. FIG. 1 or 10).

While the examples have previously been described mainly for WLAN (Wi-Fi) applications, further examples of wireless communication circuits may be configured to operate according to one of the 3GPP-standardized mobile communication networks or systems. The mobile or wireless communication system may correspond to, for example, a Long-Term Evolution (LTE), an LTE-Advanced (LTE-A), High Speed Packet Access (HSPA), a Universal Mobile Telecommunication System (UMTS) or a UMTS Terrestrial Radio Access Network (UTRAN), an evolved-UTRAN (e-UTRAN), a Global System for Mobile communication (GSM) or Enhanced Data rates for GSM Evolution (EDGE) network, a GSM/EDGE Radio Access Network (GERAN), or mobile communication networks with different standards, for example, a Worldwide Inter-operability for Microwave Access (WIMAX) network IEEE 802.16 or Wireless Local Area Network (WLAN) IEEE 802.11, generally an Orthogonal Frequency Division Multiple Access (OFDMA) network, a Time Division Multiple Access (TDMA) network, a Code Division Multiple Access (CDMA) network, a Wideband-CDMA (WCDMA) network, a Frequency Division Multiple Access (FDMA) network, a Spatial Division Multiple Access (SDMA) network, etc.

The examples as described herein may be summarized as follows:

Example 1 is a transceiver for a wireless communication system, comprising: a transmit path; a receive path; and a loopback path operatively coupled between the transmit path and the receive path, wherein the loopback path comprises only passive elements to process radio frequency signals.

In example 2, the loopback path in the transceiver of example 1 is free from inductor elements.

In example 3, the receive path in the transceiver of example 2 comprises a baseband section operating in a baseband frequency domain, and wherein the loopback path is operatively coupled to the baseband section of the receive path.

In example 4, the loopback path in the transceiver of any of examples 1 to 3 comprises at least one attenuation element.

In example 5, the attenuation element in the transceiver of example 4 is adjustable.

In example 6, the loopback path in the transceiver of any of the preceding examples comprises a mixing circuit configured to generate an analog baseband signal using an oscillation signal.

In example 7, the loopback path in the transceiver of example 6 further comprises a control circuit configured to adjust a duty cycle of the oscillation signal to one third.

In example 8, the loopback path in the transceiver of example 6 or example 7 further comprises a first capacitor element coupled to an input of the mixing circuit, and a second capacitor element coupled to an output of the mixing circuit.

In example 9, the mixing circuit together with the first and the second capacitor elements forms a low-pass filter in the transceiver of example 8.

In example 10, the transceiver of any of examples 6 to 9 further comprises a filter coupled between the transmit path and the loopback path, wherein the filter is configured to attenuate frequency components of a signal input to the filter at three times the carrier frequency of the oscillation signal.

In example 11, the transceiver of example 10 further comprises a switch circuit coupled between the transmit path and the filter, wherein the switch circuit is configured to couple the filter to the transmit path downstream of a power amplifier within the transmit path.

In example 12, the loopback path in the transceiver of any of the preceding examples is configured to supply, to the receive path, an analog baseband signal derived from a radio frequency transmit signal generated by the transmit path, wherein the transceiver further comprises a digital processor circuit configured to: receive a first digital baseband signal on which the radio frequency transmit signal is based, and a second digital baseband signal derived from the analog baseband signal; and calculate, based on the first digital signal and the second digital signal, a set of correction coefficients for compensating in-phase/quadrature imbalance within the loopback path and/or the receive path.

In example 13, the digital processor circuit in the transceiver of example 12 is configured to calculate the set of correction coefficients based on an expression which is mathematically correspondent to

d=(X^{H}X)⁻¹X^{H}y,

with d denoting the set of correction coefficients, y denoting the first digital baseband signal in a vector representation, X denoting the second digital signal in a matrix representation, and X^{H} denoting the Hermitian matrix of matrix X.

In example 14, the digital processor circuit in the transceiver of example 12 or example 13 is configured to calculate the set of correction coefficients based on an expression which is mathematically correspondent to

$$[ \begin{matrix}{d}_{1} \\ {d}_{2}\end{matrix} ] = \frac{1}{{\sum }_{n = 1}^{N} {I}_{n}^{2} \cdot {\sum }_{n = 1}^{N} {Q}_{n}^{2} - ( {\sum }_{n = 1}^{N} {I}_{n} {Q}_{n} )} [ \begin{matrix}{\sum }_{n = 1}^{N} {Q}_{n}^{2} & - {\sum }_{n = 1}^{N} {I}_{n} {Q}_{n} \\ - {\sum }_{n = 1}^{N} {I}_{n} {Q}_{n} & {\sum }_{n = 1}^{N} {I}_{n}^{2}\end{matrix} ] \cdot [ \begin{matrix}{\sum }_{n = 1}^{N} {y}_{n} {I}_{n} \\ {\sum }_{n = 1}^{N} {y}_{n} {Q}_{n}\end{matrix} ] ,$$

with d₁ and d₂ denoting first and second correction coefficients, lₙ denoting the real part of a matrix element xₙ of matrix X, Qₙ denoting the imaginary part of a matrix element xₙ of matrix X, and yₙ denoting vector elements of vector y.

In example 15, the receive path in the transceiver of any of examples 12 to 14 comprises an analog-to-digital converter configured to generate the second digital baseband signal based on the analog baseband signal

In example 16, the radio frequency transmit signal in the transceiver of any of examples 12 to 14 is a regular radio frequency transmit signal carrying user data.

In example 17, the transmit path in the transceiver of any of examples 12 to 16 further comprises a pre-distortion circuit configured to modify a baseband transmit signal based on a first pre-distortion model for compensating in-phase/quadrature imbalance within the transmit path, wherein the radio frequency transmit signal is based on the baseband transmit signal.

In example 18, the digital processor circuit in the transceiver of any of examples 12 to 17 is further configured to calculate a second pre-distortion model for a power amplifier within the transmit path using the set of correction coefficients and a calibration signal transmitted via the transmit path.

In example 19, the transmit path in the transceiver of example 18 further comprises a pre-distortion circuit configured to modify the radio frequency transmit signal using the second pre-distortion model.

Example 20 is a mobile device comprising a transceiver according to any of examples 1 to 19.

In example 21, the mobile device of example 20 further comprises at least one antenna element coupled to the transceiver.

Example 22 is a method for improving transceiver loopback calibration accuracy, wherein a receive path of the transceiver is operatively coupled to a transmit path of the transceiver via a loopback path, the method comprising: receiving a first digital baseband signal and a second digital baseband signal, wherein a radio frequency transmit signal generated by the transmit path is based on the first digital baseband signal, and wherein the second digital baseband signal is derived from an analog baseband signal, the analog baseband signal being generated by the loopback path based on the radio frequency transmit signal; determining, based on the first digital signal and the second digital signal, at least one correction coefficient for compensating in-phase/quadrature imbalance within the loopback path and/or the receive path.

In example 23, the radio frequency signal in the method of example 22 is a regular radio frequency transmit signal carrying user data.

In example 24, the radio frequency transmit signal in the method of example 22 or example 23 is based on the baseband transmit signal, the baseband transmit signal being based on a first pre-distortion model for compensating in-phase/quadrature imbalance within the transmit path.

In example 25, determining the at least one correction coefficient in the method of any of examples 22 to 24 is based on an expression which is mathematically correspondent to

d=(X^{H}X)⁻¹X^{H}y,

with d denoting the set of correction coefficients, y denoting the first digital baseband signal in a vector representation, X denoting the second digital signal in a matrix representation, and X^{H} denoting the Hermitian matrix of matrix X.

In example 26, determining the at least one correction coefficient in the method of any of examples 22 to 25 is based on an expression which is mathematically correspondent to

$$[ \begin{matrix}{d}_{1} \\ {d}_{2}\end{matrix} ] = \frac{1}{{\sum }_{n = 1}^{N} {I}_{n}^{2} \cdot {\sum }_{n = 1}^{N} {Q}_{n}^{2} - ( {\sum }_{n = 1}^{N} {I}_{n} {Q}_{n} )} [ \begin{matrix}{\sum }_{n = 1}^{N} {Q}_{n}^{2} & - {\sum }_{n = 1}^{N} {I}_{n} {Q}_{n} \\ - {\sum }_{n = 1}^{N} {I}_{n} {Q}_{n} & {\sum }_{n = 1}^{N} {I}_{n}^{2}\end{matrix} ] \cdot [ \begin{matrix}{\sum }_{n = 1}^{N} {y}_{n} {I}_{n} \\ {\sum }_{n = 1}^{N} {y}_{n} {Q}_{n}\end{matrix} ] ,$$

with d₁ and d₂ denoting first and second correction coefficients, lₙ denoting the real part of a matrix element xₙ of matrix X, Qₙ denoting the imaginary part of a matrix element xₙ of matrix X, and yₙ denoting vector elements of vector y.

In example 27, the loopback path in the method of any of the preceding examples is coupled to the transmit path downstream of a power amplifier within the transmit path.

In example 28, the loopback path in the method of any of the preceding examples comprises only passive elements for processing radio frequency signals.

In example 29, the loopback path in the method of any of the preceding examples is free from inductor elements.

In example 30, the receive path in the method of example 28 or example 29 comprises a baseband section operating in a baseband frequency domain, and wherein the loopback path is coupled to the baseband section of the receive path.

In example 31, the loopback path in the method of any of examples 22 to 27 comprises at least in part a radio frequency section of the receive path, the radio frequency section operating in a radio frequency domain.

In example 32, the method of any of the preceding examples further comprises performing a loopback calibration of the transceiver using the at least one correction coefficient.

In example 33, performing the loopback calibration in the method of example 32 comprises: transmitting a calibration signal via the transmit path; receiving the calibration signal via the receive path; and calculating a second pre-distortion model for a power amplifier within the transmit path using the received calibration signal, the transmitted calibration signal and the set of correction coefficients.

Example 34 is a means for improving transceiver loopback calibration accuracy, wherein a receive path of the transceiver is operatively coupled a transmit path of the transceiver via a loopback path, the means comprising: a means for receiving a first digital baseband signal and a second digital baseband signal, wherein a radio frequency transmit signal generated by the transmit path is based on the first digital baseband signal, and wherein the second digital baseband signal is derived from an analog baseband signal, the analog baseband signal being generated by the loopback path based on the radio frequency transmit signal; a means for determining, based on the first digital signal and the second digital signal, at least one correction coefficient for compensating in-phase/quadrature imbalance within the loopback path and/or the receive path.

In example 35, the radio frequency signal in the means of example 34 is a regular radio frequency transmit signal carrying user data.

Example 36 is a transceiver for a wireless communication system, comprising: a receive path coupled to a transmit path of the transceiver via a loopback path; and a digital processor circuit configured to: receive a first digital baseband signal and a second digital baseband signal, wherein a radio frequency transmit signal generated by the transmit path is based on the first digital baseband signal, and wherein the second digital baseband signal is derived from an analog baseband signal, the analog baseband signal being generated by the loopback path based on the radio frequency transmit signal; determine, based on the first digital signal and the second digital signal, at least one correction coefficient for compensating in-phase/quadrature imbalance within the loopback path and/or the receive path.

In example 37, the radio frequency signal in the transceiver of example 36 is a regular radio frequency transmit signal carrying user data.

In example 38, the radio frequency transmit signal in the transceiver of example 36 or example 37 is based on the baseband transmit signal, the baseband transmit signal being based on a first pre-distortion model for compensating in-phase/quadrature imbalance within the transmit path.

In example 39, the digital processing circuit in the transceiver of any of examples 36 to 38 is configured to determine the at least one correction coefficient based on an expression which is mathematically correspondent to

d=(X^{H}X)⁻¹X^{H}y,

with d denoting the set of correction coefficients, y denoting the first digital baseband signal in a vector representation, X denoting the second digital signal in a matrix representation, and X^{H} denoting the Hermitian matrix of matrix X.

In example 40, the digital processing circuit in the transceiver of any of examples 36 to 39 is configured to determine the at least one correction coefficient based on an expression which is mathematically correspondent to

$$[ \begin{matrix}{d}_{1} \\ {d}_{2}\end{matrix} ] = \frac{1}{{\sum }_{n = 1}^{N} {I}_{n}^{2} \cdot {\sum }_{n = 1}^{N} {Q}_{n}^{2} - ( {\sum }_{n = 1}^{N} {I}_{n} {Q}_{n} )} [ \begin{matrix}{\sum }_{n = 1}^{N} {Q}_{n}^{2} & - {\sum }_{n = 1}^{N} {I}_{n} {Q}_{n} \\ - {\sum }_{n = 1}^{N} {I}_{n} {Q}_{n} & {\sum }_{n = 1}^{N} {I}_{n}^{2}\end{matrix} ] \cdot [ \begin{matrix}{\sum }_{n = 1}^{N} {y}_{n} {I}_{n} \\ {\sum }_{n = 1}^{N} {y}_{n} {Q}_{n}\end{matrix} ] ,$$

with d₁ and d₂ denoting first and second correction coefficients, lₙ denoting the real part of a matrix element xₙ of matrix X, Qₙ denoting the imaginary part of a matrix element xₙ of matrix X, and yₙ denoting vector elements of vector y.

In example 41, the loopback path in the transceiver of any of examples 36 to 40 is coupled to the transmit path downstream of a power amplifier within the transmit path.

In example 42, the loopback path in the transceiver of any of examples 36 to 41 comprises only passive elements for processing radio frequency signals.

In example 43, the loopback path in the transceiver of any of examples 36 to 42 is free from inductor elements.

In example 44, the receive path in the transceiver of example 42 or example 43 comprises a baseband section operating in a baseband frequency domain, and wherein the loopback path is coupled to the baseband section of the receive path.

In example 45, the loopback path in the transceiver of any of examples 36 to 42 comprises at least in part a radio frequency section of the receive path, the radio frequency section operating in a radio frequency domain.

Example 46 is a mobile device comprising a transceiver according to any of examples 36 to 45.

In example 47, the mobile device of example 46 further comprises at least one antenna element coupled to the transceiver.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1.-25. (canceled)

26. A transceiver for a wireless communication system, comprising:
a transmit path;
a receive path; and
a loopback path operatively coupled between the transmit path and the receive path, wherein the loopback path comprises only passive elements to process radio frequency signals.

27. The transceiver of claim 26, wherein the loopback path is free from inductor elements.

28. The transceiver of claim 27, wherein the receive path comprises a baseband section operating in a baseband frequency domain, and wherein the loopback path is operatively coupled to the baseband section of the receive path.

29. The transceiver of claim 26, wherein the loopback path comprises at least one attenuation element, wherein the at least one attenuation element comprises one or more of:
an adjustable attenuation element; or
non-adjustable attenuation element.

30. The transceiver of claim 26, wherein the loopback path comprises one or more of:
a mixing circuit configured to generate an analog baseband signal using an oscillation signal;
a control circuit configured to adjust a duty cycle of the oscillation signal to one third; or
a first capacitor element coupled to an input of the mixing circuit, and a second capacitor element coupled to an output of the mixing circuit.

31. The transceiver of claim 30, wherein the mixing circuit together with the first and the second capacitor elements forms a low-pass filter.

32. The transceiver of claim 30, further comprising a filter coupled between the transmit path and the loopback path, wherein the filter is configured to attenuate frequency components of a signal input to the filter at three times the carrier frequency of the oscillation signal.

33. The transceiver of claim 32, further comprising a switch circuit coupled between the transmit path and the filter, wherein the switch circuit is configured to couple the filter to the transmit path downstream of a power amplifier within the transmit path.

34. The transceiver of claim 26, wherein the loopback path is configured to supply, to the receive path, an analog baseband signal derived from a radio frequency transmit signal generated by the transmit path, and wherein the transceiver further comprises a digital processor circuit configured to:
receive a first digital baseband signal on which the radio frequency transmit signal is based, and a second digital baseband signal derived from the analog baseband signal; and
calculate, based on the first digital signal and the second digital signal, a set of correction coefficients for compensating in-phase/quadrature imbalance within the loopback path and/or the receive path.

35. The transceiver of claim 34, wherein the digital processor circuit is configured to calculate the set of correction coefficients based on an expression which is mathematically correspondent to:
d=(X^{H}X)⁻¹X^{H}y,
with d denoting the set of correction coefficients, y denoting the first digital baseband signal in a vector representation, X denoting the second digital signal in a matrix representation, and X^{H} denoting the Hermitian matrix of matrix X.

36. The transceiver of claim 34, wherein the digital processor circuit is configured to calculate the set of correction coefficients based on an expression which is mathematically correspondent to:
$$[ \frac{{d}_{1}}{{d}_{2}} ] = \frac{1}{{\sum }_{n = 1}^{N} {I}_{n}^{2} \cdot {\sum }_{n = 1}^{N} {Q}_{n}^{2} - ( {\sum }_{n = 1}^{N} {I}_{n} {Q}_{n} )} [ \begin{matrix}{\sum }_{n = 1}^{N} {Q}_{n}^{2} & - {\sum }_{n = 1}^{N} {I}_{n} {Q}_{n} \\ - {\sum }_{n = 1}^{N} {I}_{n} {Q}_{n} & {\sum }_{n = 1}^{N} {I}_{n}^{2}\end{matrix} ] \cdot [ \begin{matrix}{\sum }_{n = 1}^{N} {y}_{n} {I}_{n} \\ {\sum }_{n = 1}^{N} {y}_{n} {Q}_{n}\end{matrix} ] ,$$
with d₁ and d₂ denoting first and second correction coefficients, Iₙ denoting the real part of a matrix element xₙ of matrix X, Qₙ denoting the imaginary part of a matrix element xₙ of matrix X, and yₙ denoting vector elements of vector y.

37. The transceiver of claim 34, wherein the receive path comprises an analog-to-digital converter configured to generate the second digital baseband signal based on the analog baseband signal.

38. The transceiver of claim 34, wherein the radio frequency transmit signal is a regular radio frequency transmit signal carrying user data.

39. The transceiver of claim 34, wherein the transmit path further comprises a pre-distortion circuit configured to modify a baseband transmit signal based on a first pre-distortion model for compensating in-phase/quadrature imbalance within the transmit path, wherein the radio frequency transmit signal is based on the baseband transmit signal.

40. The transceiver of claim 34, wherein the digital processor circuit is further configured to calculate a second pre-distortion model for a power amplifier within the transmit path using the set of correction coefficients and a calibration signal transmitted via the transmit path.

41. The transceiver of claim 40, wherein the transmit path further comprises a pre-distortion circuit configured to modify the radio frequency transmit signal using the second pre-distortion model.

42. A mobile device comprising:
an antenna element; and
a transceiver operatively coupled to the antenna element and comprising:
a transmit path;
a receive path; and
a loopback path operatively coupled between the transmit path and the receive path, wherein the loopback path comprises only passive elements to process radio frequency signals.

43. A method for improving transceiver loopback calibration accuracy, wherein a receive path of the transceiver is operatively coupled to a transmit path of the transceiver via a loopback path, the method comprising:
receiving a first digital baseband signal and a second digital baseband signal, wherein a radio frequency transmit signal generated by the transmit path is based on the first digital baseband signal, and wherein the second digital baseband signal is derived from an analog baseband signal, the analog baseband signal being generated by the loopback path based on the radio frequency transmit signal;
determining, based on the first digital signal and the second digital signal, at least one correction coefficient for compensating in-phase/quadrature imbalance within the loopback path and/or the receive path.

44. The method of claim 43, wherein the radio frequency signal is a regular radio frequency transmit signal carrying user data.

45. The method of claim 43, wherein the radio frequency transmit signal is based on the baseband transmit signal, the baseband transmit signal being based on a first pre-distortion model for compensating in-phase/quadrature imbalance within the transmit path.
